(19) United States
(12) Patent Application Publication
(10) Pub. No.: US 2012/0141217 A1
(43) Pub. Date: Jun. 7, 2012

(54) ZEROABLE DEPTH SCALE FOR DRILL PRESSES AND METHODS THEREFOR

(75) Inventor: Thomas Benton Sharp, Jackson, TN (US)

(73) Assignee: Black & Decker Inc., Newark, DE (US)

(21) Appl. No.: 12/960,523

(22) Filed: Dec. 5, 2010

(51) Int. Cl. B23B 49/00; B23B 35/00; B23B 47/00

(52) U.S. Cl. 408/1 R; 408/16; 408/241 S

(57) ABSTRACT

A drill press includes a head stock, a pinion shaft, and a quill coupled with the pinion shaft. A pinion shaft hub is connected with an outer end of the pinion shaft and is located adjacent a side wall of the head stock. The pinion shaft hub is rotatable for rotating the pinion shaft, which provides reciprocating movement to the quill along a vertical axis. A stationary zeroing element is mounted on the head stock, and a depth scale is mounted on the pinion shaft hub adjacent the stationary zeroing element. The depth scale and the pinion shaft hub are frictionally coupled together so that the depth scale normally rotates simultaneously with the pinion shaft hub, however, the depth scale is rotatable relative to the pinion shaft hub upon exceeding a friction force that normally resists movement of the depth scale relative to the pinion shaft hub.

### BACKGROUND OF THE INVENTION

1. Field of the Invention

The present invention generally relates to drill presses and more specifically relates to depth scales for drill presses.

2. Description of the Related Art

Drill presses are used for drilling holes in work pieces such as sheet metal and wood. Typically, a drill press includes a work piece supporting table that is used to stabilize work pieces during drilling operations, and to insure that the work pieces are aligned with a rotating drill bit for accurately drilling holes in the work pieces.

Many drill presses have depth stops and/or depth scales that control how far a rotating drill bit may be lowered into a work piece. For example, U.S. Pat. No. 5,096,340 to Forsgren discloses a drill press having a quick-adjust depth scale. The quick adjust-depth scale includes a handle clamp assembly whereby the clamp has an opening in which a cylindrical shaft with suitable depth measurement markings thereon is received. Turning the handle on the clamp enables the depth scale to be set to a desired depth.

U.S. Pat. No. 5,577,868 to Chen discloses a depth stop for a drill press including a block having a central passage and a cut-away laterally defined therein that communicates with the central passage. The depth stop includes an oblong element received in the cut-away and a resilient element disposed between the oblong element and the block. The oblong element has an oblong hole defined therein and has a threaded portion defined on an inner periphery of the oblong hole for engagement with a threaded rod that extends through the central passage of the block and the oblong hole of the oblong element. The block is freely moveable along the threaded rod by depressing the oblong element to compress the resilient element and disengage the threaded portion of the oblong element from the threaded rod.

In spite of the above advances, there remains a need for improved depth stops and/or depth scales for drill presses. In particular, there remains a need for a zeroable depth scale for a drill press that enables operators to efficiently and accurately position a drill bit on top of a work piece and zero the scale and select a desired drilling depth without requiring the operator to perform mathematical calculations from a fixed depth scale.

### SUMMARY OF THE INVENTION

In one embodiment, a drill press having a zeroable depth scale preferably includes a head stock mounted atop a support column, a pinion shaft rotatable about a horizontal axis extending through the head stock, the pinion shaft having an outer end that extends through a side wall of the head stock, and a quill coupled with the pinion shaft and projecting from a bottom of the head stock along a vertical axis. The drill press desirably includes a pinion shaft hub connected with the outer end of the pinion shaft and being located adjacent the side wall of the head stock. The pinion shaft hub is preferably rotatable for rotating the pinion shaft about the horizontal axis, which, in turn, provides reciprocating movement to the quill along the vertical axis. The drill press desirably includes a stationary zeroing element mounted on the head stock and disposed between the side wall of the head stock and the pinion shaft hub, and a depth scale mounted on the pinion shaft hub adjacent the stationary zeroing element. The depth scale and the pinion shaft hub are preferably frictionally coupled together so that the depth scale normally rotates simultaneously with the pinion shaft hub, however, the depth scale is rotatable relative to the pinion shaft hub upon exceeding a friction force that normally resists movement of the depth scale relative to the pinion shaft hub.

In one embodiment, the pinion shaft hub desirably has an inner section including an annular groove and an outer section having at least one anchor point for a pinion shaft handle. The depth scale may be frictionally coupled with the annular groove of the pinion shaft hub. The depth scale preferably has a ring shape and is frictionally coupled with the annular groove of the pinion shaft hub.

In one embodiment, the depth scale preferably has depth measuring indicia located adjacent the stationary zeroing element. The stationary zeroing element may include a stationary ring having a zero marker mounted on the side wall of the head stock. The pinion shaft desirably extends through the stationary ring. In one embodiment, upon overcoming the friction force, the depth scale is rotatable relative to the pinion shaft hub for aligning one of the depth measuring indicia of the depth scale with the zero marker of the stationary ring. In one embodiment, the depth scale has a depth measuring indicator identified as “zero” that is aligned with the zero marker on the stationary ring for zeroing the depth scale.

In one embodiment, the drill press desirably includes a quill bracket connected with the quill, the quill bracket including a quill bracket opening, and a stop bracket connected with the head stock, the stop bracket including a stop bracket opening that is vertically aligned with the quill bracket opening. The drill press preferably has a rod having an upper end, a lower end, and a length extending between the upper and lower ends thereof. The rod extends through the quill bracket opening and the stop bracket opening and the lower end of the rod is desirably connected with the quill bracket. A lower locking element is mounted on the rod and is lockable at a plurality of locations along the length of the rod between the quill bracket and the stop bracket, and an upper locking element is mounted on the rod and is lockable at a plurality of locations along the length of the rod between the stop bracket and the upper end of the rod.

In one embodiment, the quill bracket is adapted to move simultaneously with the quill as the quill moves along the vertical axis. The quill bracket is preferably adapted to move relative to the stop bracket as the quill moves along the vertical axis.

In one embodiment, the rod desirably has an outer surface including external threads, and the lower and upper locking elements have central apertures including internal threads that are adapted to mesh with the external threads of the rod. At least one of the locking elements preferably includes a biased element that is depressible for decoupling the internal threads of the at least one of the locking elements from the external threads of the rod for enabling the at least one of the locking elements to slide over the external threads of the rod. When the biased element is not depressed, at least one of the locking elements is rotatable about the rod for moving the at least one of the locking elements between the upper and lower ends of the rod.

In one embodiment, a drill press having a zeroable depth scale preferably includes a support column having an upper end and a lower end, a head stock connected to the upper end of the support column, a base connected to the lower end of the support column, and a work piece supporting table coupled with the support column. The drill press desirably includes a pinion shaft having an outer end extending through a side wall of the head stock, a quill coupled with the pinion shaft and projecting along a vertical axis from a bottom of the head stock, a spindle connected with the quill and projecting along the vertical axis from a lower end of the quill, a chuck connected with the spindle and projecting along the vertical axis from a lower end of the spindle, and a drill bit connected with the chuck and projecting along the vertical axis from a lower end of the chuck.

The drill press may include a pinion shaft hub coupled with the outer end of the pinion shaft and being located adjacent the side wall of the head stock, whereby the pinion shaft hub is rotatable for rotating the pinion shaft, which, in turn, provides reciprocating movement to the quill, the spindle, the chuck, and the drill bit along the vertical axis. A stationary zeroing element is desirably mounted on the head stock and disposed between the side wall of the head stock and the pinion shaft hub, and a depth scale mounted on the pinion shaft hub adjacent the stationary zeroing element, the depth scale frictionally coupled to the pinion shaft hub so that the depth scale normally moves simultaneously with the pinion shaft hub. The depth scale is moveable relative to the pinion shaft hub upon exceeding a friction force that normally resists movement of the depth scale relative to the pinion shaft hub.

In one embodiment, the pinion shaft hub preferably has an inner section including an annular groove and an outer section having at least one anchor point for a pinion shaft handle. The depth scale preferably has a ring shape and is frictionally coupled about the annular groove of the pinion shaft hub. The depth scale desirably has depth measuring indicia located adjacent the stationary zeroing element, the stationary zeroing element includes a stationary ring having a zero marker and the pinion shaft extends through the stationary ring. Upon the depth scale overcoming the friction force, the depth measuring indicia is alignable with the zero marker.

In one embodiment, a method of zeroing a drill press desirably includes rotating the pinion shaft hub for lowering the drill bit until it touches a work piece overlying the work piece supporting table, moving the lower locking element toward the upper end of the rod until the lower locking element abuts against a bottom surface of the stop bracket, rotating the depth scale on the pinion shaft hub so that a zero indicator on the depth scale is aligned with the zero marker of the stationary ring, and removing the work piece from the work piece supporting table and rotating the pinion shaft hub to lower the drill bit to a desired drilling depth as indicated by the depth measuring indicia of the depth scale.

In one embodiment, the method may include while maintaining the drill bit at the desired drilling depth, moving the lower locking element toward the upper end of the rod until the lower locking element engages the bottom surface of the stop bracket, while still maintaining the drill bit at the desired drilling depth, lowering the upper locking element toward the lower end of the rod until the upper locking element engages the top surface of the stop bracket, and moving the lower locking element away from the stop bracket.

These and other preferred embodiments of the present invention will be described in more detail below.

### BRIEF DESCRIPTION OF THE DRAWING

FIG. 1 shows a perspective view of a drill press having a zeroable depth scale, in accordance with one embodiment of the present invention.

FIG. 2 includes a perspective view of a drill press including a head stock and a quill projecting downwardly from the head stock, in accordance with one embodiment of the present invention.

FIG. 3 shows a perspective view of a zeroable depth scale for a drill press including a pinion shaft hub and a zeroable depth scale that is rotatable relative to the pinion shaft hub.

FIG. 4 shows a front elevational view of the pinion shaft hub and the zeroable depth scale of FIG. 3.

FIG. 5 shows a front elevational view of the pinion shaft hub of FIG. 4 with the zeroable depth scale removed for clarity, in accordance with one embodiment of the present invention.

FIG. 6 shows a cross-sectional view of the pinion shaft hub and the zeroable depth scale taken along line VI-VI of FIG. 4.

FIG. 7 shows a drill press including a zeroable depth scale during a drilling operation, in accordance with one embodiment of the present invention.

### DETAILED DESCRIPTION

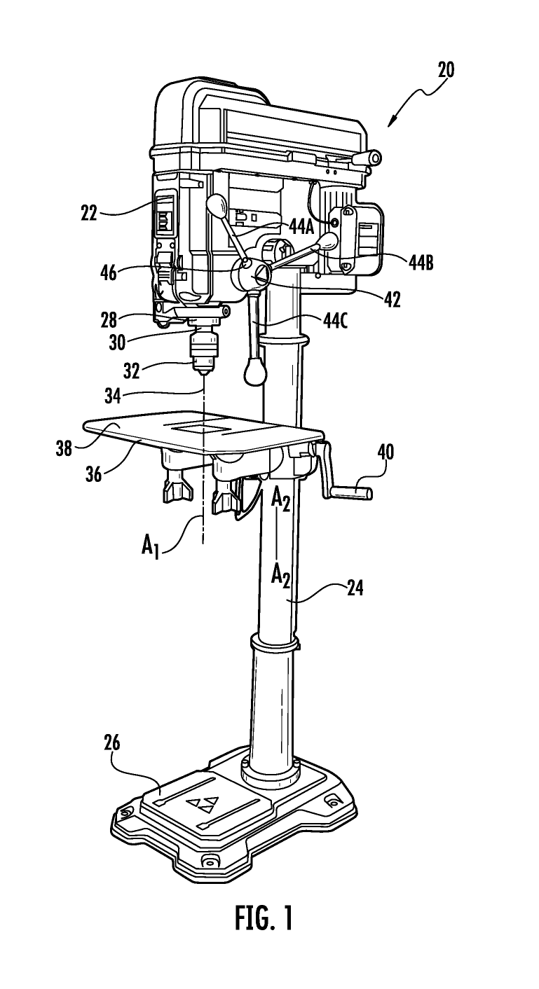

Referring to FIG. 1, in one embodiment, a drill press 20 having a zeroable depth scale preferably includes a head stock 22 connected to an upper end of a vertically-extending support column 24 and a base 26 connected to a lower end of the support column. The drill press 20 desirably includes a quill 28 that is mounted for reciprocating movement relative to the head stock 22 along a vertical axis A₁. The drill press includes a spindle shaft 30 that is mounted within the quill 28 for rotation about the vertical axis A₁. A chuck 32, mountable to a lower end of the spindle shaft 30, is preferably adapted to receive a drill bit 34 used for drilling holes in work pieces. Other tools may also be secured to the lower end of the chuck 32, such as a sanding tool.

The drill press 20 desirably includes a table 36 having a top surface 38 adapted to support work pieces. The table 36 is preferably coupled with the vertical support column 24. The table may be moved up and down the support column 24 by cranking a table handle 40 that is coupled with a rack and pinion structure (not shown). In one embodiment, the table 36 may be rotated about the support column 24, or placed at a non-perpendicular angle relative to the longitudinal axis A₂ of the support column. When positioned atop the table 36, the work pieces are preferably aligned with the drill bit 34 for drilling holes in the work pieces.

The drill press 20 preferably includes a pinion shaft for providing reciprocating movement of the quill 28 along the vertical axis A₁. In one embodiment, the drill press 20 includes a pinion shaft hub 42 that is mounted on a rotatable pinion shaft (not shown) that extends horizontally through the head stock 22. Pinion shaft handles 44A-44C are secured to the pinion shaft hub 42. The pinion shaft is coupled with the quill 28 so that as an operator turns the pinion shaft hub 42 using the pinion shaft handles 44A-44C, the quill 28 will move up or down along the vertical axis A₁. This vertical motion may be used to advance the drill bit 34 into drilling engagement with a work piece supported over the top surface 38 of the table 36.

The drill press 20 preferably includes a zeroable depth scale that is used for controlling the depth of holes drilled into work pieces. In one embodiment, the zeroable depth scale desirably includes a rotatable ring that is mounted on the pinion shaft hub 42. The rotatable ring preferably has a scale for measuring, selecting and setting drilling depths. The rotatable ring is frictionally coupled with the pinion shaft hub 42 so that it may be selectively rotated relative to the pinion shaft hub only after overcoming a friction force that normally resists movement between the depth scale ring and the pinion shaft hub. The pinion shaft hub 42 preferably has an outer surface having at least one anchor point 46 for receiving a pinion shaft handle.

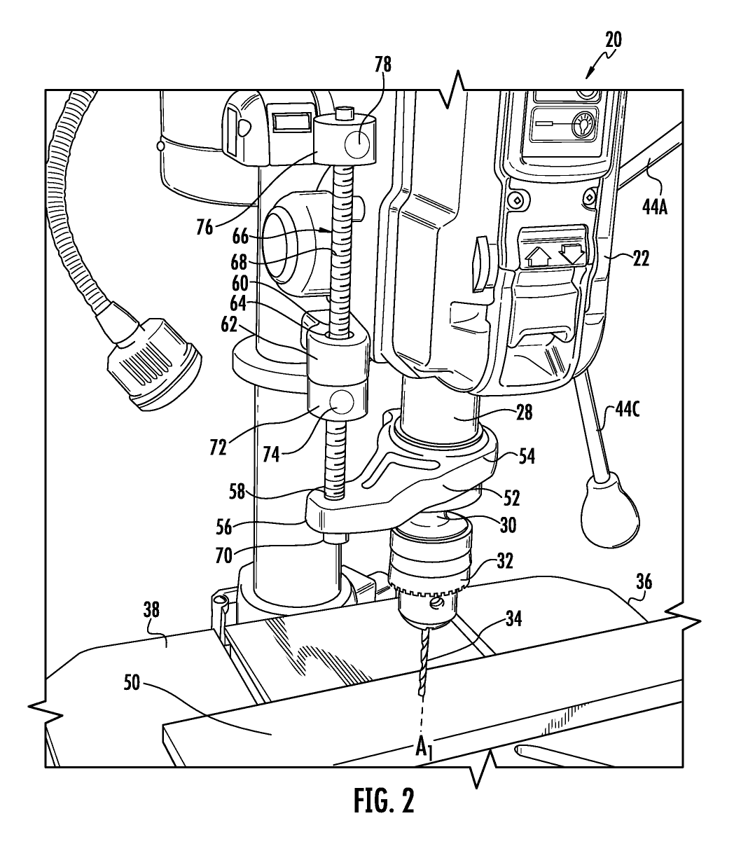

FIG. 2 shows a work piece 50 overlying the top surface 38 of the table 36. The work piece 50 is preferably aligned with the drill bit 34 so that the drill bit 34 may be lowered toward the work piece 50 for accurately drilling holes therein. The drill press 20 includes the head stock 22 having the quill 28 projecting downwardly therefrom along the vertical axis A₁. The rotatable spindle 30 is mounted to a lower end of the quill 28. In turn, the chuck 32 is mounted to a lower end of the spindle 30, and the drill bit 34 is secured to the lower end of the chuck 32. In use, an operator may engage the pinion shaft handles 44A-44C (FIG. 1) for rotating the pinion shaft hub 42 and the pinion shaft, which, in turn, lowers the quill 28, the spindle 30, the chuck 32, and the drill bit 34 toward the table 36 along the vertical axis A₁.

In one embodiment, the drill press 20 desirably includes a quill bracket 52 having a first end 54 mounted to the quill 28 and a second end 56 having a quill bracket opening 58 extending therethrough. The quill bracket 52 preferably moves simultaneously with the quill 28. The drill press preferably includes a stop bracket 60 that is secured to the head stock 22. The stop bracket 60 preferably includes a stop flange 62 connected therewith having a stop bracket opening 64 extending therethrough that is preferably vertically aligned with the quill bracket opening 58. As the quill 28 moves upwardly along the vertical axis A₁, the quill bracket 52 preferably moves toward the stop bracket 60. As the quill 28 moves downwardly along the vertical axis A₁, the quill bracket 52 preferably moves away from the stop bracket 60.

The drill press preferably includes a threaded rod 66 that extends through the quill bracket opening 58 in the quill bracket 52 and the stop bracket opening 64 in the stop flange 62 of the stop bracket 60. In one embodiment, the threaded rod 66 desirably extends along a vertical axis that is parallel with the vertical axis A₁. The threaded rod 66 desirably has an outer surface having external threads 68 formed thereon. In one embodiment, the external threads are desirably helically wound about the threaded rod 66. A fastener 70, such as a locking nut 70, desirably connects a lower end of the threaded rod 66 with the quill bracket 52 so that the quill bracket 52 and the threaded rod 66 may move simultaneously with one another.

The drill press also desirably includes a lower locking element 72 that has internal threads that mesh with the external threads 68 on the threaded rod 66. The lower locking element 72 preferably includes a depressable button 74 that may be pressed for decoupling the internal threads of the lower locking element 72 from the external threads 68 of the threaded rod 66 so that the lower locking element 72 may slide over external threads 68 for quickly adjusting the position of the lower locking element 72 relative to the threaded rod 66. When the button 74 is not depressed, the internal threads of the lower locking element engage the external threads of the threaded rod so that the lower locking element 72 may only be raised and lowered on the rod by rotation of the lower locking element 72.

The drill press also preferably includes an upper locking element 76 that has internal threads that engage the external threads 68 of the threaded rod 66. The upper locking element 76 desirably has a depressable button 78 that may be pressed for decoupling the internal threads of the upper locking element 76 from the external threads 68 of the threaded rod 66 so that the upper locking element 76 may slide over external threads 68 for quickly adjusting the position of the upper locking element 76 relative to the threaded rod 66. When the button 78 is not depressed, the internal threads of the upper locking element 76 engage the external threads of the threaded rod so that the upper locking element may only be raised and lowered on the rod by rotation of the upper locking element 76.

In one embodiment, the upper and lower locking elements 72, 76 may be rotated about the threaded rod 66 for making micro-adjustments of the upper and lower locking elements 72, 76 along a longitudinal axis of the threaded rod 66. The depressable buttons 74, 78 of the respective upper and lower locking elements 72, 76 may be depressed for decoupling the inner threads of the respective upper and lower locking elements from the threaded rod for making gross adjustments of the upper and lower locking elements along the longitudinal axis of the threaded rod 66.

The stop bracket 60 is permanently attached to the head stock 22 and does not move relative to the head stock. The quill bracket 52 is permanently attached to the quill 28 and moves up and down with the quill along the vertical axis A₁. As the quill 28 moves up and down along the vertical axis A₁, the quill bracket 52 moves simultaneously with the quill and moves relative to the stop bracket 60.

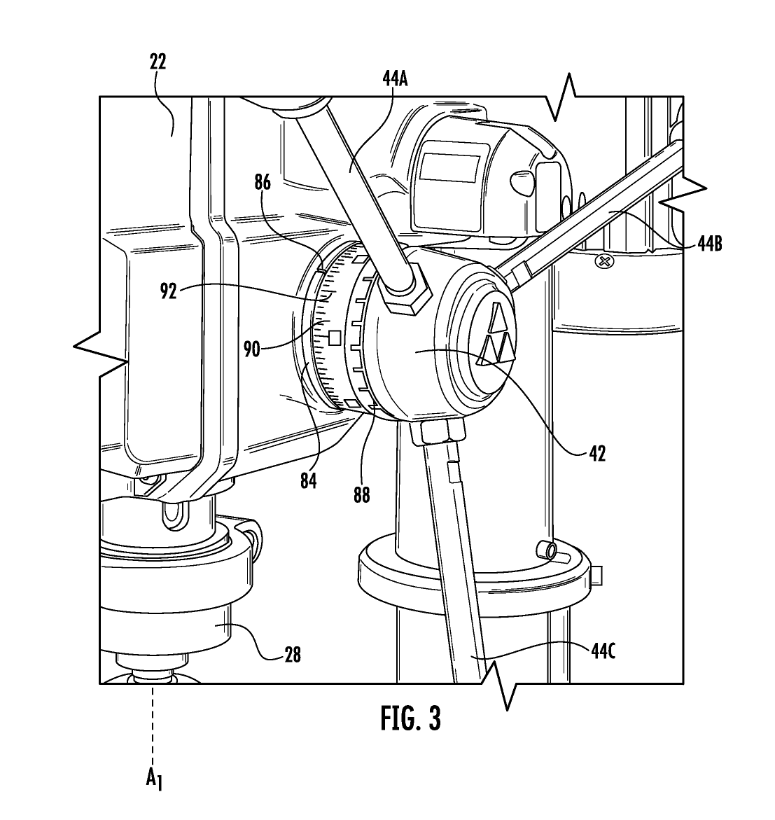

Referring to FIGS. 3-6, in one embodiment, the drill press preferably includes a zeroable depth scale 90 that is mounted on the pinion shaft hub 42. In one embodiment, the head stock 22 includes a stationary element 84, such as a stationary ring maintained on the side wall of the head stock 22, having a zero marker 86, such as an etched line, formed therein that serves as a zero point for alignment. The pinion shaft hub 42 has an annular groove 88 formed therein and the depth scale 90 is mounted on the annular groove 88. The depth scale 90 may have a ring shape and a depth measuring indicia 92 provided thereon that is used in conjunction with the zero marker 86 on the stationary element.

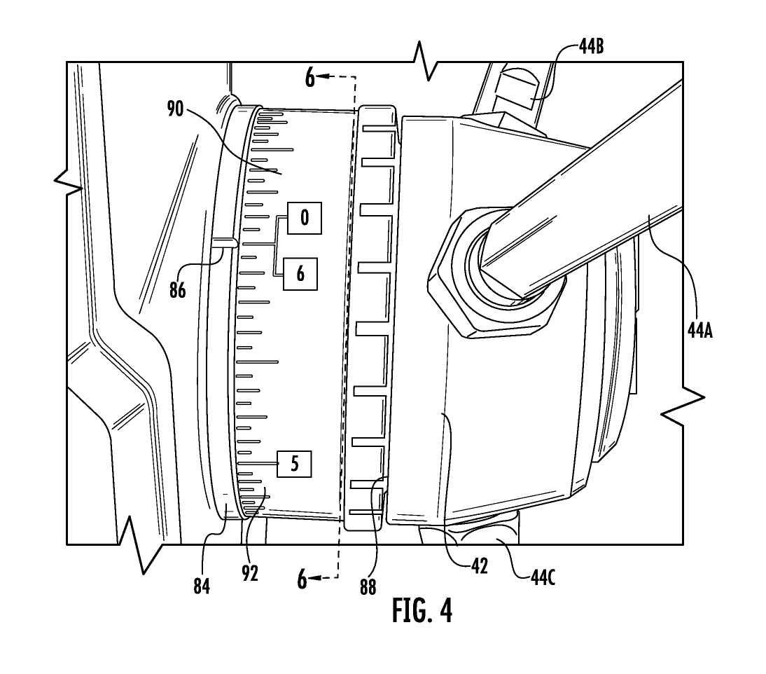

Referring to FIG. 4, in one embodiment, the depth scale 90 is frictionally coupled about the annular groove 88 provided on the pinion shaft hub 42. As the pinion shaft hub 42 is rotated by the pinion shaft handles 44A-44C, the depth scale 90 normally rotates simultaneously with the pinion shaft hub 42 due to a frictional engagement between the depth scale 90 and an annular groove 88 of the pinion shaft hub 42. Upon overcoming a friction force, however, an operator may rotate the depth scale 90 relative to the annular groove 88 of the pinion shaft hub 42. As used herein, the term “friction force” means a force on objects in contact with each other that resists motion of the objects relative to one another.

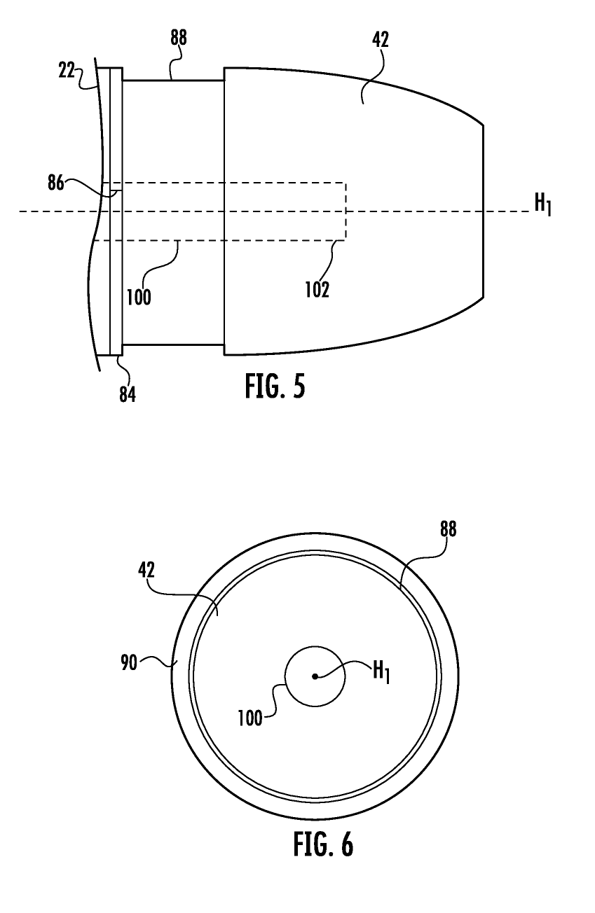

Referring to FIG. 5, in one embodiment, the drill press 20 includes a pinion shaft 100 having an outer end 102 extending through a sidewall of the head stock 22. The pinion shaft hub 42 is coupled to the outer end 102 and is located adjacent to the side wall of the head stock 22. As the pinion shaft hub 42 is rotated by the pinion shaft handles (not shown), the pinion shaft hub rotates the pinion shaft 100 about a horizontally extending axis designated H₁. The pinion shaft hub 42 includes the annular groove 88 that is adapted to receive the depth scale 90 (FIG. 4), which is not shown in FIG. 5 for purposes of clarity. The stationary element 84 with the zero marker 86 is mounted to the head stock 22 and remains stationary relative to the head stock 22. During rotation of the pinion shaft hub 42, the depth scale 90 normally rotates with the pinion shaft hub. However, an operator may overcome the frictional friction force that normally resists movement for rotating the depth scale relative to the pinion shaft hub for selecting a desired drilling depth and/or aligning a zero indicator on the depth scale with the zero marker 86 on the stationary element 84.

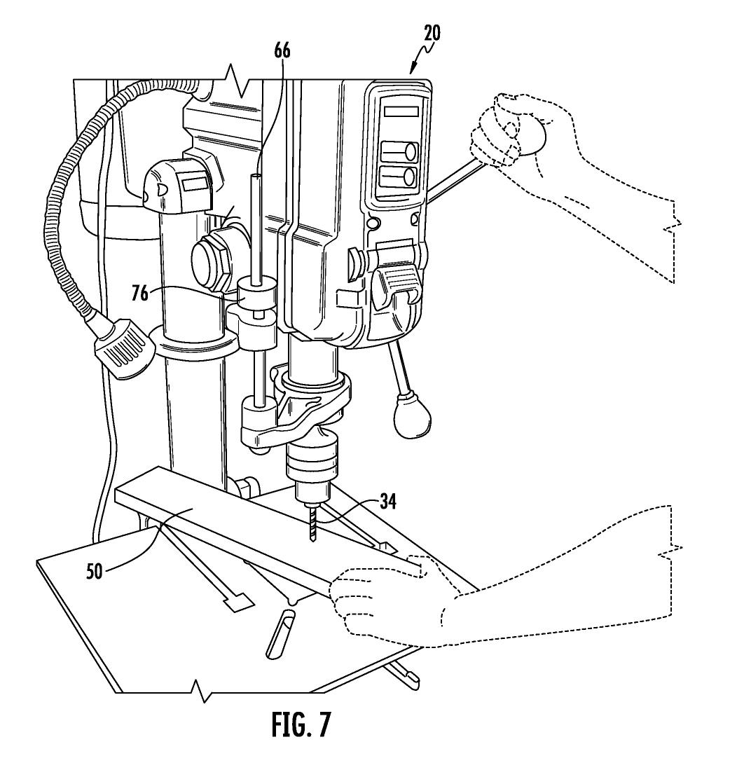

FIG. 6 shows a cross-sectional view of the depth scale 90 seated in the annular groove 88 of the pinion shaft hub 42. As the pinion shaft hub 42 is rotated about the horizontal axis H₁, the depth scale ring 90 normally rotates simultaneously with the pinion shaft hub 42. However, an operator may overcome frictional forces resisting movement between the depth scale 90 and the pinion shaft 42 by rotating the depth scale 90 relative to the pinion shaft hub 42.

Referring to FIGS. 2-4, in one embodiment, in order to measure the depth of a work piece, zero the drill press and/or select a desired drilling depth, a drill bit 34 is secured to a lower end of the chuck 32. The operator engages the pinion shaft handles 44A-44C for lowering the drill bit 34 toward the work piece 50 until the lower end of the drill bit touches the work piece. In order to zero the depth scale 90, the operator presses the depressable button 74 on the lower locking element 72 and raises it along the threaded rod 66 until it abuts against a bottom surface of the stop flange 62 of the stop bracket 60. The operator will then preferably rotate the zeroable depth scale 90 relative to the annular groove 88 of the pinion shaft hub 42 (overcoming the frictional resistance) until a zero marker on the depth scale ring 90 is aligned with a zero line 86 on the stationary element 84.

The operator may then remove the work piece 50 and rotate the pinion shaft handles 44A-44C to lower the quill 28 to a desired drilling depth as indicated by the scale markings 92 on the depth scale 90. While holding the quill 28 at the desired drilling depth, the operator preferably depresses the button 74 on the lower locking element 72 and raises the lower locking element 72 until it abuts against the bottom surface of the stop flange 62 of the stop bracket 60. While the quill 28 is held at this depth by the lower locking element 72, the operator preferably presses the button 78 on the upper locking element 76 and lowers the upper locking element 76 down against a top surface of the stop flange 62 of the stop bracket 60. The upper locking element has now been positioned at a location on the threaded rod that will stop the drill bit 34 from advancing beyond the desired drilling depth for drilling into the work piece 50. The operator may move the lower locking element 72 away from the stop flange 62.

Referring to FIG. 7, in one embodiment, an operator may connect the drill press 20 with a power source and lower the drill bit 34 for drilling a test hole in the work piece 50. The operator may make fine re-adjustments to the drilling depth by rotating the upper locking element 76 about the threaded rod 66. In order to make fine adjustments to the position of the upper locking element 76, it is not necessary to depress the button 78 on the upper locking element 76.

The present invention enables operators to efficiently and accurately measure a drilling depth, establish a desired drilling depth, and zero the scale on a depth scale without requiring calculations from a fixed depth scale. The advantages include that a user is able to position a depth scale including a rotatable ring over a smooth surface without coming into contact with sharp pointers and without requiring the user to make mathematical calculations, which could lead to errors.

The headings used herein are for organizational purposes only and are not meant to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

While the foregoing is directed to embodiments of the present invention, other and further embodiments of the invention may be devised without departing from the basic scope thereof, which is only limited by the scope of the claims that follow. For example, the present invention contemplates that any of the features shown in any of the embodiments described herein, or incorporated by reference herein, may be incorporated with any of the features shown in any of the other embodiments described herein, or incorporated by reference herein, and still fall within the scope of the present invention.

What is claimed is:

1. A drill press having a zeroable depth scale comprising:
a head stock mounted atop a support column;
a pinion shaft rotatable about a horizontal axis extending through said head stock, said pinion shaft having an outer end that extends through a side wall of said head stock;
a quill coupled with said pinion shaft and projecting from a bottom of said head stock along a vertical axis;
a pinion shaft hub connected with said outer end of said pinion shaft and being located adjacent said side wall of said head stock, wherein said pinion shaft hub is rotatable for rotating said pinion shaft about the horizontal axis, which, in turn, provides reciprocating movement to said quill along the vertical axis;
a stationary zeroing element mounted on said head stock and disposed between said side wall of said head stock and said pinion shaft hub;
a depth scale mounted on said pinion shaft hub adjacent said stationary zeroing element, said depth scale and said pinion shaft hub being frictionally coupled together so that said depth scale normally rotates simultaneously with said pinion shaft hub, said depth scale being rotatable relative to said pinion shaft hub upon exceeding a friction force that normally resists movement of said depth scale relative to said pinion shaft hub.

2. The drill press as claimed in claim 1, wherein said pinion shaft hub comprises an inner section including an annular groove and an outer section having at least one anchor point for a pinion shaft handle.

3. The drill press as claimed in claim 2, wherein said depth scale has a ring shape and is frictionally coupled about said annular groove of said pinion shaft hub.

4. The drill press as claimed in claim 3, wherein said depth scale is frictionally coupled with said annular groove of said pinion shaft hub.

5. The drill press as claimed in claim 4, wherein said depth scale has depth measuring indicia located adjacent said stationary element.

6. The drill press as claimed in claim 5, wherein said stationary zeroing element comprises a stationary ring having a zero marker mounted on said side wall of said head stock, and said pinion shaft extending through said stationary ring.

7. The drill press as claimed in claim 6, wherein upon overcoming the friction force said depth scale is rotatable relative to said pinion shaft hub for aligning one of said depth measuring indicia of said depth scale with said zero marker of said stationary ring.

8. The drill press as claimed in claim 1, further comprising:
a quill bracket connected with said quill, said quill bracket including a quill bracket opening;
a stop bracket connected with said head stock, said stop bracket including a stop bracket opening that is vertically aligned with said quill bracket opening;
a rod having an upper end, a lower end, and a length extending between said upper and lower ends thereof, wherein said rod extends through said vertically aligned quill bracket opening and said stop bracket opening and said lower end of said rod is connected with said quill bracket;
a lower locking element mounted on said rod and being lockable at a plurality of locations along the length of said rod between said quill bracket and said stop bracket;
an upper locking element mounted on said rod and being lockable at a plurality of locations along the length of said rod between said stop bracket and said upper end of said rod.

9. The drill press as claimed in claim 8, wherein said quill bracket is adapted to move simultaneously with said quill as said quill moves along the vertical axis.

10. The drill press as claimed in claim 9, wherein said quill bracket is adapted to move relative to said stop bracket as said quill moves along the vertical axis.

11. The drill press as claimed in claim 8, wherein said rod has an outer surface including external threads, and wherein said lower and upper locking elements have central apertures including internal threads that are adapted to mesh with said external threads of said rod.

12. The drill press as claimed in claim 11, wherein at least one of said locking elements includes a biased element that is depressible for decoupling said internal threads of said at least one of said locking elements from said external threads of said rod for enabling said at least one of said locking elements to slide over said external threads of said rod.

13. The drill press as claimed in claim 11, wherein at least one of said locking elements is rotatable about said rod for moving said at least one of said locking elements between said upper and lower ends of said rod.

14. A drill press having a zeroable depth scale comprising:
a support column having an upper end and a lower end;
a head stock connected to said upper end of said support column;
a base connected to said lower end of said support column;
a work piece supporting table coupled to said support column;
a pinion shaft having an outer end extending through a side wall of said head stock, said pinion shaft having an outer end that extends through a side wall of said head stock;
a quill coupled with said pinion shaft and projecting along a vertical axis from a bottom of said head stock;
a spindle connected with said quill and projecting along the vertical axis from a lower end of said quill;
a chuck connected with said spindle and projecting along the vertical axis from a lower end of said spindle;
a drill bit connected with said chuck and projecting along the vertical axis from a lower end of said chuck;
a pinion shaft hub coupled with said outer end of said pinion shaft and being located adjacent said side wall of said head stock, wherein said pinion shaft hub is rotatable for rotating said pinion shaft, which, in turn, provides reciprocating movement to said quill, said spindle, said chuck, and said drill bit along the vertical axis;
a stationary zeroing element mounted on said head stock and disposed between said side wall of said head stock and said pinion shaft hub;
a depth scale mounted on said pinion shaft hub adjacent said stationary zeroing element, said depth scale frictionally coupled to said pinion shaft hub so that said depth scale normally moves simultaneously with said pinion shaft hub, yet said depth scale being moveable relative to said pinion shaft hub upon exceeding a friction force that normally resists movement of said depth scale relative to said pinion shaft hub.

15. The drill press as claimed in claim 14, wherein said pinion shaft hub comprises an inner section including an annular groove and an outer section having at least one anchor point for a pinion shaft handle.

16. The drill press as claimed in claim 15, wherein said depth scale has a ring shape and is frictionally coupled about said annular groove of said pinion shaft hub.

17. The drill press as claimed in claim 16, wherein said depth scale has depth measuring indicia located adjacent said stationary zeroing element, said stationary zeroing element includes a stationary ring having a zero marker and said pinion shaft extends through said stationary ring, and wherein upon said depth scale overcoming the friction force said depth measuring indicia is alignable with said zero marker.

18. The drill press as claimed in claim 17, further comprising:
a quill bracket connected with said quill, said quill bracket including a quill bracket opening;
a stop bracket connected with said head stock, said stop bracket including a stop bracket opening that is vertically aligned with said quill bracket opening;
a rod having an upper end, a lower end, and a length extending between said upper and lower ends thereof, wherein said rod extends through said quill bracket opening and said stop bracket opening and said lower end of said rod is connected with said quill bracket;
a lower locking element mounted on said rod and being lockable at a plurality of locations along the length of said rod between said quill bracket and said stop bracket;
an upper locking element mounted on said rod and being lockable at a plurality of locations along the length of said rod between said stop bracket and said upper end of said rod.

19. A method of zeroing a drill press using said drill press of claim 18, the method comprising:
rotating said pinion shaft hub for lowering said drill bit until it touches a work piece overlying said work piece supporting table;
moving said lower locking element toward said upper end of said rod until said lower locking element abuts against a bottom surface of said stop bracket;
rotating said depth scale on said pinion shaft hub so that a zero indicator on said depth scale is aligned with said zero marker of said stationary ring;
removing said work piece from said work piece supporting table and rotating said pinion shaft hub to lower said drill bit to a desired drilling depth as indicated by said depth measuring indicia of said depth scale.

20. The method as claimed in claim 19, further comprising:
while maintaining said drill bit at the desired drilling depth, moving said lower locking element toward said upper end of said rod until said lower locking element engages said bottom surface of said stop bracket;
while still maintaining said drill bit at the desired drilling depth, lowering said upper locking element toward said lower end of said rod until said upper locking element engages said top surface of said stop bracket;
moving said lower locking element away from said stop bracket.
